(19) United States
(12) Patent Application Publication
(10) Pub. No.: US 2007/0199540 A1
(43) Pub. Date: Aug. 30, 2007

(54) METHOD FOR CONTROLLING THE IDLE SPEED OF AN INTERNAL COMBUSTION ENGINE, AND AN INTERNAL COMBUSTION ENGINE

(76) Inventors: Stefan Solyom, Goteborg (SE); Thomas Lyngfelt, Goteborg (SE); Soren Eriksson, Kungalv (SE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/674,217

(22) Filed: Feb. 13, 2007

(30) Foreign Application Priority Data
Feb. 24, 2006 (EP) 06110397.4

(51) Int. Cl. F02P 5/15; F02D 41/00

(52) U.S. Cl. 123/339.11; 123/339.25; 123/361

(57) ABSTRACT

A method for controlling the idle speed of an internal combustion engine is presented. The method comprises controlling an ignition timing at least partly based on the engine speed and controlling a position of a throttle valve at least partly based on the ignition timing. Preferably, the ignition timing is controlled so that it is restricted by at least one ignition timing limit, and the position of the throttle valve is controlled at least partly based on the ignition timing as not restricted by the at least one ignition timing limit.

### TECHNICAL FIELD

The present invention relates to a method for controlling the idle speed of an internal combustion engine, as well as an internal combustion engine comprising a control unit for controlling the idle speed of the engine.

### BACKGROUND AND SUMMARY

Idling is one of the most often used functionalities in the modern car. This is especially the case in city traffic, where there are frequent stop and go situations. Therefore, improvements in the control performance for the idle speed control unit have always been a high priority. A good control performance keeps the engine speed at a desired set-point value, and ensures good disturbance rejection while maintaining low fuel consumption. Typical disturbances that are to be rejected by the controller are loads from the air-conditioning system, or power steering. Such a disturbance load will manifest itself as a disturbance torque on the engine. Obviously, one should be able to compensate for the disturbance by using the throttle. However, due to the slow dynamics of the air mass in the intake manifold, this would generate an unacceptably slow disturbance rejection. For this reason, a second control signal is used, namely, the ignition timing, also referred to as the spark advance. By advancing or retarding the ignition one can obtain an instantaneous torque variation from the engine. However, a deviation from the optimal spark ignition will result in higher fuel consumption. Thus, the use of this signal should be kept at minimum and used only for improving the speed of the disturbance rejection. From a control point of view, this is a difficult problem since the system in question is nonlinear, multivariable (two inputs) and time varying. Moreover, the throttle control channel has a slower dynamics than that of the ignition timing.

In known art, for example U.S. Pat. No. 6,688,282B1, this problem is usually approached by treating the two control channels separately (one control signal is set to constant while the other is modified), leading to performance degradation, (see also Hrovat, D. and Sun, J. (1997): Models and control methodologies for IC engine idle speed control design, Control Eng. Practice, 5, Nr. 8, pp. 1093-1100).

Some other known approaches treat linearized models resulting in local designs. There are approaches where both control signals are treated in the same time (multivariable control). However, the resulting controllers are highly complex and difficult to tune, (see, for example, Green, J. and Hedrick, J. K. (1990): Nonlinear Speed Control for Automotive Engines, Proc. of the ACC, San Diego, Calif., pp. 2891-2897, or Stotsky, A. et al. (2000): Variable Structure Control of Engine Idle Speed with Estimation of Unmeasurable Disturbances, Journal of Dynamics Systems, Measurement and Control, Vol. 122, pp. 599-603).

This invention is directed to improving idle speed control of an internal combustion engine, and more particularly to improving capabilities of keeping the idle speed of an internal combustion engine at a desired position, improving disturbance rejection at idle speed control of an internal combustion engine while maintaining a low fuel consumption at idle speed control of an internal combustion engine.

Accordingly, a method for controlling the idle speed of an internal combustion engine includes adjusting an ignition timing at least partly based on the engine speed and adjusting a position of a throttle valve at least partly based on said adjusted ignition timing. The invention, suitable for engines with spark ignition, provides, as shown closer below, a very fast disturbance rejection. Furthermore, as also shown closer below, the invention provides robustness within a large span of idle speed set points.

Preferably, the ignition timing is controlled so that it is restricted by at least one ignition timing limit, and the position of the throttle valve is controlled at least partly based on the ignition timing as not restricted by the at least one ignition timing limit. As described closer below, this will provide a way to avoid limitations of the throttle control, caused by physical constraints of the ignition timing, such as risks of engine knock and combustion instability. When such physical constraints of the ignition timing are reached, the throttle controller can be augmented such that the throttle will generate more control action. This will infer a faster response to the overall control system, and also a faster convergence of the engine speed to its desired value.

### DESCRIPTION OF THE DRAWINGS

Below, the invention will be described closer with reference to the drawings, in which

FIG. 1 shows schematically parts of an internal combustion engine;

FIG. 2 shows a block diagram depicting a method according to one embodiment of the invention;

FIG. 3 shows a block diagram depicting the method in FIG. 2 a cascade control structure;

FIG. 4 shows a diagram with an ignition timing interval; and

FIGS. 5-7 show simulation results for three respective idle speed set-points.

### DETAILED DESCRIPTION

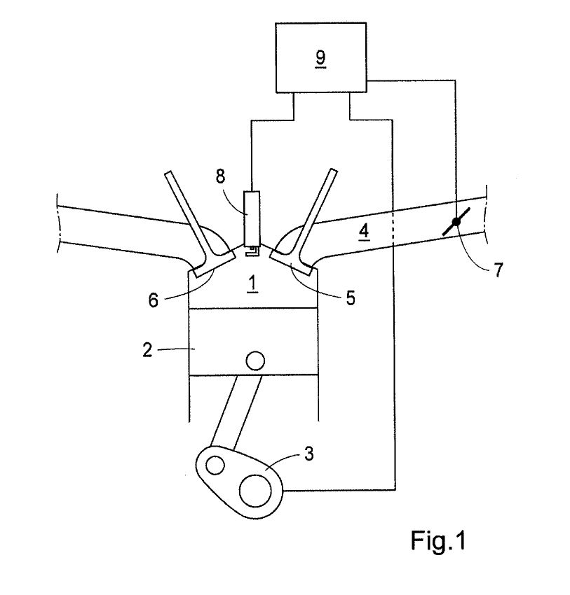

FIG. 1 shows schematically parts of an internal combustion engine, comprising a cylinder 1, a piston 2, a crankshaft 3, an inlet manifold 4, an inlet and an outlet valve 5, 6, a throttle valve 7 in the inlet manifold, and a spark plug 8. A control unit in the form of an engine control unit (ECU) 9 is provided. The ECU 9 has computational and data storage capabilities, and can be provided as one physical unit, or alternatively as a plurality of logically interconnected units. The ECU 9 is arranged to receive signals corresponding to the engine speed, for example by means of a toothed wheel on the crankshaft 3. The ECU 9 is also arranged to send control signals so as to control the position of the throttle valve 7. Further, the ECU is arranged to send control signals so as to control the timing of spark ignitions of the spark plug 8.

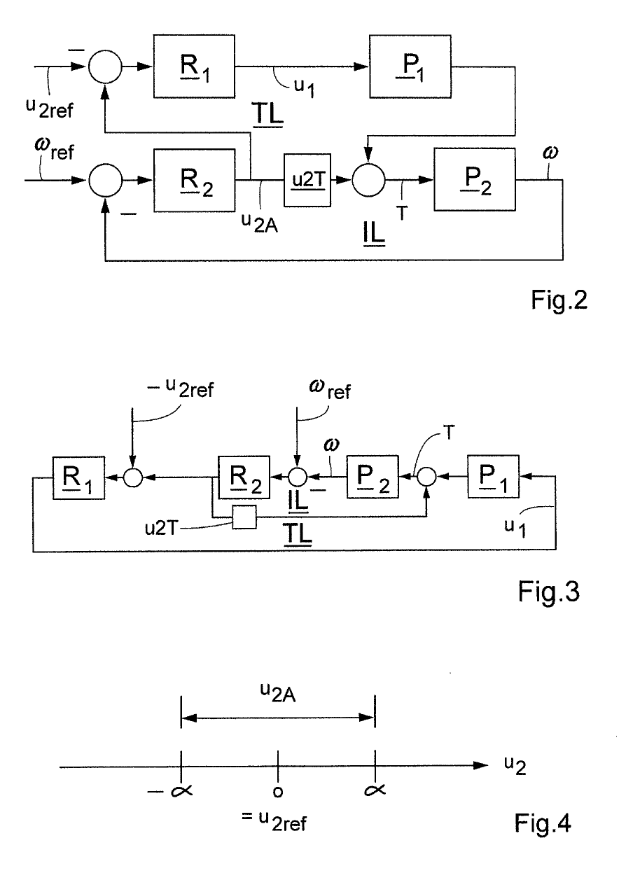

FIG. 2 shows a block diagram depicting the method of the ECU 9 to control the idle speed of the engine. As explained in greater detail below, the method comprises controlling an ignition timing u_{2A} at least partly based on the engine speed ω, and controlling a position u₁ of the throttle valve 7 at least partly based on the ignition timing. The ignition timing u_{2A} is the timing of ignitions of the spark plug 8 in relation the position of the crankshaft 3. As explained closer below, due to physical constraints, such as risks of engine knock and combustion instability, the ignition timing u_{2A} is restricted by ignition timing limits, i.e., it has a limited control authority. For this presentation, the ignition timing restricted in this manner is referred to as the actual ignition timing u_{2A}.

As depicted in FIG. 2, the engine speed ω is controlled by a fast control loop, here also referred to as the ignition timing control loop IL. The ignition timing control loop IL includes an ignition timing controller R₂, suitably a PID controller, adapted to control the actual ignition timing u_{2A} based on the engine speed ω and a reference value of the engine speed ω_{ref}, which could also be referred to as the desired engine speed ω_{ref}. Adjusting the actual ignition timing u_{2A} results in an almost instantaneous torque response from the engine. The influence of the actual ignition timing u_{2A} on the engine torque T is depicted in FIG. 2 with a block u2T, and the engine process relating the torque T to the engine speed is depicted with a block P₂.

Another loop, herein referred to as the throttle control loop TL, contains slower dynamics, where a throttle controller R₁, suitably a PID controller, is adapted to adjust the position of the throttle valve 7, i.e., the throttle angle u₁, such that in stationary, the ignition timing u_{2A} will converge to a reference value of the ignition timing u_{2ref}. (The ignition timing u_{2A} can also be referred to as the spark advance u₂, defined in relation to the reference value of the ignition timing u_{2ref}.)

The reference value of the ignition timing u_{2ref} is a predetermined value chosen so that a good tradeoff is made between a good disturbance rejection and low fuel consumption. Increasing the torque reserve increases the idle speed disturbance rejection capability, but it also increases the low fuel consumption. On the other hand, a small or no torque reserve provides low fuel consumption but decreases the disturbance rejection capability. More specifically, the engine has optimal fuel consumption with relation to the delivered torque at MBT (minimum spark advance for the best torque). Any deviation from this point decreases the efficiency of the engine, but an imposed steady state deviation from MBT provides a torque reserve. In other words, the reference value of the ignition timing u_{2ref} is a predetermined value which differs from a maximum torque providing ignition timing, but which still keeps the fuel consumption relatively low.

The influence of the throttle angle u₁ on the engine torque T is depicted in FIG. 2 with a block P₁. (As stated, the engine process relating the torque T to the engine speed is depicted with a block P₂.) It can be seen in FIG. 2 that by controlling the throttle position u₁ to adjust the ignition timing u_{2A}, an indirect adjustment of the engine speed ω is obtained. The influence of the control signal for the throttle angle u₁ on the engine speed ω is quite slow, but it can generate large torques, i.e., it has a large control authority.

The method described above with reference to FIG. 2 means that the throttle is governed by the error between the reference and actual ignition timing, while the ignition timing is governed by the engine speed error. This method can also be depicted as a structure similar to cascade control, with an inner and an outer loop IL, TL, as illustrated in FIG. 3. The inner loop IL, controls the ignition timing and the outer loop TL controls the position of the throttle 7. As explained above, the influence of the ignition timing channel is faster than the throttle channel.

Reference is made to FIG. 4. As mentioned, due to physical constraints, such as risks of engine knock and combustion instability, the actual ignition timing u_{2A} is bound by ignition timing limits α, i.e., it has a limited control authority, in FIG. 3a depicted by the interval [−α, α]. Typically, this authority is not more than ±15 crankshaft angle degrees, in relation to the reference value of the ignition timing u_{2ref}. Since the throttle position is controlled partly based on the ignition timing, it is desirable to avoid limitations of the throttle control due to limitations of the actual ignition timing u_{2A}.

To avoid such limitations of the throttle control, the position u₁ of the throttle valve 7 can be controlled at least partly based on the ignition timing as not restricted by the ignition timing limits −α, α. For this presentation, the ignition timing as not restricted by the ignition timing limits −α, α is also referred to as a theoretical ignition timing u_{2D}. Thus, the theoretical ignition timing u_{2D} able to assume values outside the limitations −α, α of the actual ignition timing u_{2A}. Preferably, the method includes establishing a value of the theoretical ignition timing u_{2D}, and if this value is outside any of the limits of the actual ignition timing u₂, controlling the throttle position partly based on the theoretical ignition timing u_{2D}.

One way of doing this is adding, in the process described above, a feedforward term u_{FF} to the reference value of the ignition timing u_{2ref}, which term can be defined as follows:

u_{FF}=K_{FF}ω_{ref}dzn_{α}u_{2D},

where

$${dzn}_{α} {u}_{2 D} = \{ \begin{matrix}{u}_{2 D} - α , & {u}_{2 D} > α \\ 0 , & \vert {u}_{2 D} \vert \leq α \\ - {u}_{2 D} + α , & {u}_{2 D} < - α\end{matrix}$$

where α is the absolute value of the limits of the actual ignition timing u_{2A}. In this example, the lower and upper limits of the actual ignition timing are at the same distance α from the reference value u_{2ref}, but of course in general the lower and upper limits could be at different distances from the reference value u_{2ref}.

The feedforward term u_{FF} provides a way to compare the theoretical ignition timing u_{2D} to the limits of the actual ignition timing u_{2A}, and while these are different, augment the throttle controller R₁ such that the throttle will generate more control action. This will infer a faster response to the overall control system, and also a faster convergence of the engine speed to its desired value.

As an alternative, the throttle position could be controlled based partly on the theoretical ignition timing u_{2D}, but not based on the actual ignition timing u_{2A}.

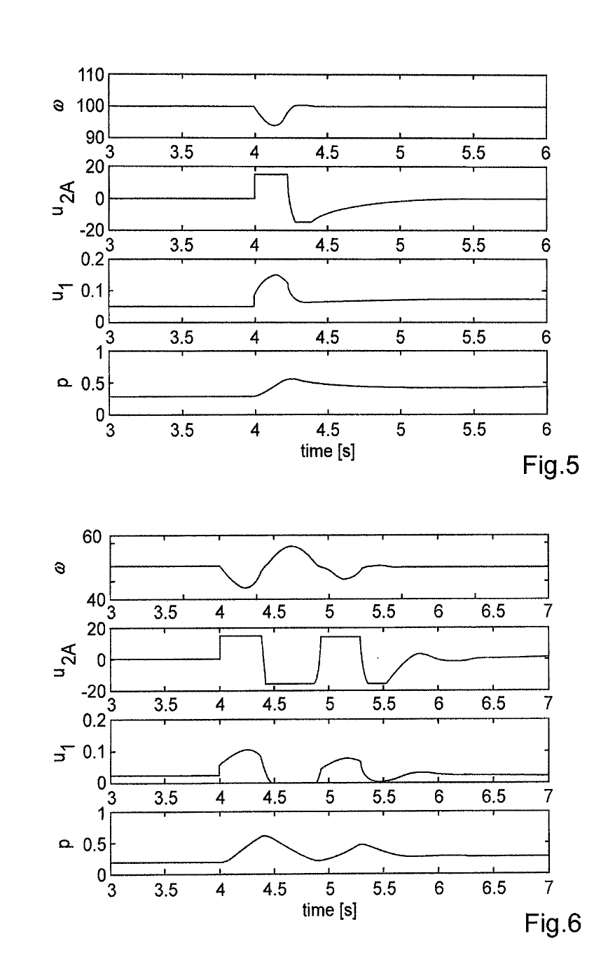

The invention provides a design for idle speed control which is very robust for a large span of idle speed set-points. Support for this can be seen in FIGS. 5-7, which show simulation results obtained by the inventors for three respective idle speed set-points, while the control system was tuned for 1000 rpm. The simulation scenario consists of 4 seconds where the control system holds the set-point followed by a 20 Nm step disturbance at t=4 s. The controller compensates for the disturbance by a coordinated action on the ignition timing u_{2A} and the throttle position u₁, according to the invention.

In FIG. 5, a case is shown with a desired idle speed ω_{ref} of 100 rad/s. As shown in the simulation, the rejection of the disturbance is extremely fast, the engine speed returns to the set-point value within 0.25 seconds without ever falling below 94 rad/s. It is interesting to note that the throttle overshoots its steady state value in order to speed up the disturbance rejection. This requires a negative compensation from the spark advance in order not to overshoot the reference value of the engine speed ω_{ref}, (i.e., the desired engine speed). This cooperation between the two control channels results in a superior control performance.

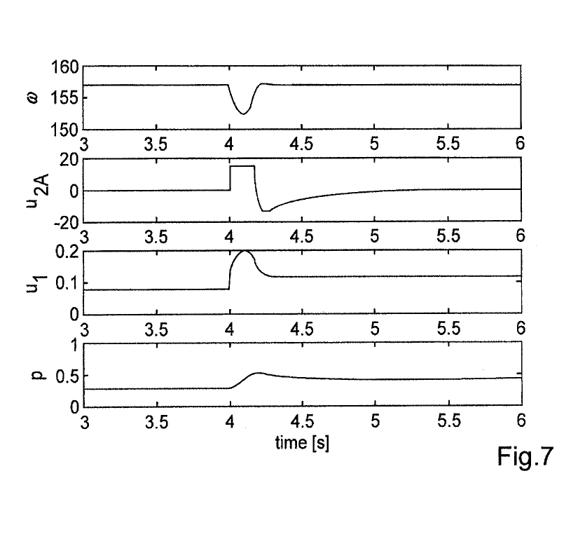

In FIG. 6, the response for a reference value of the engine speed ω_{ref} of 48 rad/s is shown. Normally, such a deviation from the nominal set-point is not applied for most vehicle engines, but it is shown to highlight the robustness of the method according to the invention. Finally, FIG. 7 shows the case for a high engine speed, 1500 rpm, demonstrating the fast response and robustness of the method according to the invention.

1. A method for controlling idle speed of an internal combustion engine, comprising:
adjusting ignition timing at least partly based on engine speed; and
adjusting throttle valve position at least partly based on said adjusted ignition timing.

2. The method according to claim 1, wherein ignition timing is adjusted so that it is restricted by at least one ignition timing limit and a position of the throttle valve is controlled at least partly based on the ignition timing as not restricted by the at least one ignition timing limit.

3. The method according to claim 2, including determining a theoretical value of the ignition timing, and if the theoretical value of the ignition timing is outside the at least one ignition timing limit, controlling the position of the throttle valve partly based on the ignition timing as not restricted by the at least one ignition timing limit.

4. The method according to claim 3, wherein the position of the throttle valve is controlled partly based on a reference value of the ignition timing.

5. The method according to claim 4, wherein the reference value of the ignition timing is a predetermined value which is different from an ignition timing value providing a maximum torque of the engine at idling.

6. The method according to claim 5, wherein the ignition timing controlled at least partly based on a reference value of the engine speed.

7. An internal combustion engine comprising a control unit for controlling the idle speed of the engine, the control unit being adapted to control an ignition timing at least partly based on the engine speed, said control unit further adapted to control a position of a throttle valve at least partly based on the ignition timing.

8. The internal combustion engine according to claim 7, wherein the control unit is adapted to control the ignition timing so that it is restricted by at least one ignition timing limit, and to control the position of the throttle valve (7) at least partly based on the ignition timing as not restricted by the at least one ignition timing limit.

9. The internal combustion engine according to claim 8, wherein the control unit is adapted to determine a theoretical value of the ignition timing, and to control, if the theoretical value of the ignition timing is outside the at least one ignition timing limit, the position of the throttle valve partly based on the ignition timing as not restricted by the at least one ignition timing limit.

10. The internal combustion engine according to claim 9, wherein the control unit is adapted to control the position of the throttle valve partly based on a reference value of the ignition timing.

11. The internal combustion engine according to claim 10, wherein the reference value of the ignition timing is a predetermined value which is different from an ignition timing value providing a maximum torque of the engine at idling.

12. The internal combustion engine according to claim 11, wherein the control unit is adapted to control the ignition timing at least partly based on a reference value of the engine speed.
